(19) United States
(12) Patent Application Publication
(10) Pub. No.: US 2015/0278855 A1
(43) Pub. Date: Oct. 1, 2015

(54) DATA ACQUISITION, ADVERTISING, AND COMPENSATION

(71) Applicant: Joseph Khoury, Boca Raton, FL (US)

(72) Inventor: Joseph Khoury, Boca Raton, FL (US)

(21) Appl. No.: 14/229,821

(22) Filed: Mar. 28, 2014

(51) Int. Cl. G06Q 30/02

(52) U.S. Cl. CPC G06Q 30/0251; G06Q 30/0273

(57) ABSTRACT

Users of computing devices can be compensated for sharing data and accepting advertisements on their computing devices. Compensation can also depend on supply of particular data and performing specific actions, such as personal information and various designations and authorizations. In one instance, compensation can depend on supplying personal information and providing designation and authorization with respect to a purchase agent and purchase of products or services.

### BACKGROUND

Most people at one point in time in their lives will purchase products and services through intermediaries. Insurance products or services fall into this category, so does financial products such as the sale of securities, bonds, stock assets, and or even the sale of telecommunication services, such as mobile phone services. In most cases, intermediaries receive commissions from a company. For example, insurance, such as automobile, health, and life insurance, is typically sold through insurance agents acting as intermediaries or brokers. Insurance products can be purchased from captive agents that represent large insurance companies or from independent agents that offer products from multiple insurance companies. Insurance agents receive commissions based on the number of customers and the amount of premiums the agents bring to the insurance companies. To maximize revenue, independent agents conventionally concentrate their business on a few insurance companies with which they have negotiated the best commission and compensation terms based on expected volume and quality of the risks they are expected to bind for insurers. Some agents have tried to extend their reach by building comparison websites to provide quotes online and other agents rely on direct face-to-face sale, but both approaches are costly. Intermediaries face the same problems and challenges even if the basic need for the product they represent is very strong and common across the entire population, namely they need to prospect and capture new customers even though their differentiation capabilities may be small.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data acquisition, advertising, and compensation. In exchange for sharing data, accepting advertisements, and optionally performing other actions, users of computing devices can be compensated. The level of compensation can also be contingent or adjustable based on supply of particular data and performance of specific actions. In one instance, compensation can depend on a user supplying personal information and performing an action with respect to an intermediary and purchase of products or services. Mechanisms are also provided to at least facilitate auctioning users to a product or service provider based on intermediary compensation, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a compensation system.

FIG. 2 is a block diagram of a representative agent component.

FIG. 3 is a block diagram of a representative bid component.

FIG. 4 is a flow chart diagram of a user compensation method.

FIG. 5 is a flow chart diagram of a user compensation method.

FIG. 6 is a flow chart diagram of a method agent designation and purchase with user compensation.

FIG. 7 is a flow chart diagram of a method of switching providers.

FIG. 8 is a flow chart diagram of a method of user compensation.

FIG. 9 is a schematic block diagram illustrating a suitable operating environment for aspects of the subject disclosure.

### DETAILED DESCRIPTION

Details below generally pertain to data acquisition, advertisement, and compensation. A user of computing device, including mobile devices such as a laptop, tablet, or smart phone, can be compensated for sharing data and allowing delivery of advertisements to the computing device based at least in part on the data shared. Compensation can also be contingent or adjustable based on supply of particular data and performance of specific actions. For example, compensation can depend on a user providing personal information (e.g., name, address, birth date, current location . . . ), filling in forms, visiting a website, and providing various designations and authorizations, for instance with respect to purchase of products or services. As other examples, compensation can be impacted by the frequency, type, and delivery of advertisements allowed by a user. Compensation is provided as an incentive for users to surrender data/information that they would otherwise maintain as private. Although not limited thereto, compensation can be financial in accordance with one embodiment. In this case, at least a portion of revenue acquired from advertisers or other sources can be utilized to compensate users resulting in a cost efficient solution for acquiring data regarding users on a large scale.

In accordance with one embodiment, aspects of this disclosure are applicable to intermediaries, such as purchase agents or brokers. One exemplary purchase agent is an insurance agent. Here, in addition to sharing data such as current location, other personal information relating to the acquisition of insurance (e.g., make of vehicle, vehicle identification number (VIN) . . . ) can be supplied by a user in various forms. Further, various designations and authorizations related to the purchase of insurance products can be provided, such as designation of an insurance agent and authorization to switch insurance carriers or renew a policy with a current carrier but through a different agent. Since customers are generally indifferent as to which agent they use to obtain coverage, offering moneymaking opportunity is a cost effective way to convince customers on a massive scale to select a specific agent.

In accordance with another embodiment, an intermediary can refer a user to a particular business or location for purchase of a product or service. For example, an intermediary can request that a user purchase a product or service by way of a particular website, for instance. A user can purchase a product or service indirectly by way of the website specified by an intermediary. Further, the user can be compensated in some way for such a purchase.

Intermediate compensation can also be improved. Data shared by a user can be utilized to encourage service providers to pay higher overall compensation to a user-selected intermediary. In the case of insurance products and services for example, customers can be placed in various risk groups and auctioned to insurance companies based on risk groups with the insurance companies bidding higher commissions or agent compensation for the customers in a lower risk group that is expected to cost less in overall claims. Accordingly, insurance agents are provided with increased leverage to negotiate commissions and compensation terms with insurance companies as risk groups can be determined through the data including but not limited to current location of the user, car model, age, among other things shared by the user in exchange for user compensation. Further, intermediaries can acquire referral fees or the like for referring users to business for purchase of products or services, for example by way of a website or call center.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

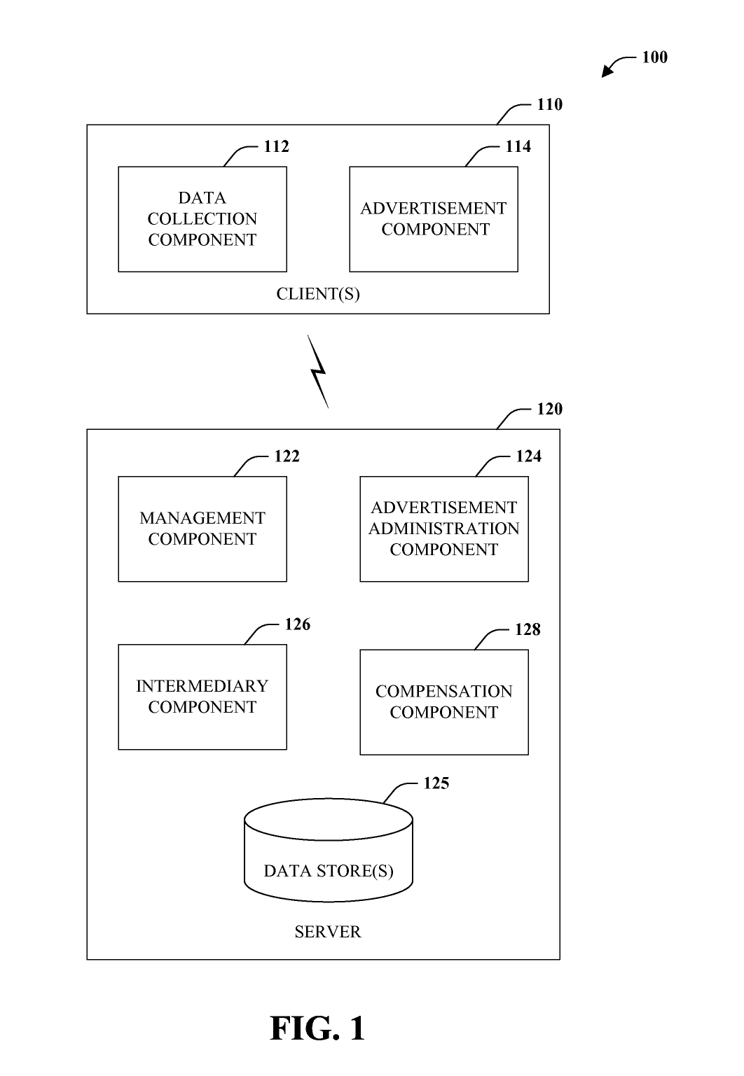

Referring initially to FIG. 1, a compensation system 100 is illustrated. Although not limited thereto, the compensation system 100 can be implemented in two-tier architecture, as shown. As such, workload can be distributed between providers of a resource or service and requestors of the resource or service. Here, client 110 corresponds to software that is executable on a computing device, such as a laptop, tablet, or smartphone. Server 120 corresponds to software that is executable in the context of a computing device that executes server software to facilitate servicing one or more clients. The client 110 and server 120 can interact by way of network communication (e.g., Internet).

The client 110 includes data collection component 112 and advertisement component 114. Although not limited thereto, the data collection component 112 and advertisement component 114 can form part of an application installed on a computing device. For example, the application can be downloaded from an online store (a.k.a., application store or application marketplace) and installed, for instance on a mobile computing device such as a smart phone. In accordance with one embodiment, an intermediary can make this application available to clients and prospective clients.

The data collection component 112 is configured to collect data about a user of a computing device. By way of example, data corresponding to location, speed, and acceleration can be collected from one or more sensors of the computing device. For example, utilizing an installed global positioning system (GPS) receiver, proximity sensor, cellular phone signal triangulation, or other mechanisms location can be determined and tracked. The data collection component 112 can also be configured to acquire data directly or indirectly from a user. For instance, a user can directly enter or otherwise specify data by way of an input mechanism (e.g., keyboard, touch screen, voice, gesture . . . ) about themselves such as age, date of birth, address marital status, and occupation, among other things. Additionally or alternatively, data can be collected automatically, for instance from other applications or the like. As examples, data can be acquired from a personal information manager (PIM) application that manages contacts, calendars, appointments, tasks, and other personal data or one or more social network applications. Of course, collection and the manner of collection can be subject to privacy controls that require user permission.

The advertisement component 114 is configured to display, present, or otherwise deliver advertisements on a computing device. Advertisements can be received, retrieved, or otherwise obtained or acquired from one or more external sources. Subsequently, the advertisements can be delivered in conjunction with one or more applications or system software of a computing device or independent thereof Advertisements can vary in form, including text, images, audio, video, or a combination thereof, as well as delivery. As examples, advertisements can be displayed visibly on mobile phone lock screen or presented audibly in connection with a music player or turn-by-turn direction application. Additional examples of advertisements that can be employed in conjunction the advertisement component 114 are described latter herein.

The advertisement component 114 can also allow a user to control or manage advertisements. In one instance, advertisement component 114 can enable a user manage the frequency of advertising where a high frequency results in greater compensation and a low frequency results in less compensation, for instance. Similarly, a user can manage the type and delivery of advertisements by way of the advertisement component 114. In this way, the user can manage delivery of advertisements providing compensation versus his/her desire for privacy.

The server 120 is configured to interact with and service the one or more clients 110 in a variety of ways. The server 120 includes management component 122, advertisement administration component 124, intermediary component 126, and compensation component 128. The management component 122 is configured to manage or coordinate actions performed by and with respect to client components or applications comprising client components. The advertisement administration component 124 is configured to for sell advertisements for computer devices based on acquired user data (e.g., location or location patterns), for instance. The intermediary component 126 is configured to acquire information and request performance of one or more actions with respect to purchase of products or services and a particular intermediary. The compensation component 128 is configured to determine and at least initiate compensation of a user for sharing particular data/information, accepting advertising, and performing specific actions. Further, one or more data stores 125 provide persistent storage as part of a data storage system or computer-readable storage media to at least support operations of the management component 122, the advertisement administration component 124, the intermediary component 126, and the compensation component 128.

The management component 122 can receive, retrieve, or otherwise obtain or acquire data collected by the data collection component 112 and save the data to the data store 125. Various types of data can be collected including, among other things, current and past location. Further, other types of data or information can be determined or inferred based on collected data. By way of example, and not limitation, behavior, demographics, and movement can be inferred from location data. For instance, by continuously tracking location and utilizing other information such as the day of week and time of day, a user's home and place of employment can be determined. For example, a home zone can be determined based on typical location patterns of a user's computing device at night. Specific routes can also be inferred (e.g., drive home route, drive to preferred shopping center route, drive to preferred friends/relatives routes . . . ). This inferred information will be used to increase the target accuracy of an advertisement and potential payout to the user. Collected and generated data regarding a user can be saved to the data store 125.

The advertisement administration component 124 provides functionality for selling advertisements on computer devices based on collected, determined, or inferred data/information. For example, a business or merchant can purchase the right to deliver an advertisement when a user of a computing device is a specified distance from the merchant. The advertising, however, can be arbitrarily complex, for instance to maximize targeting capabilities and merchant value. For example, whether or not an advertisement is presented can depend on the day of the week, the time of day, the season, and user characteristics such as sex, age, education level, home zone (e.g., where the user lives), and ethnicity, among other things. Further, advertisements can vary based on type (banner, audio, video, text), and delivery. For example, a visual advertisement can be displayed on lock screen or notification screen, or an audio advertisement played before or after making phone calls, listening to music, or receiving directions, among other things. The advertisement administration component 124 can accept bids and payment regarding advertising.

The management component 122, alone or in combination with the advertisement administration component 124, is further configured ensure particular advertisements are available for display, presentation, or the like on a computing device in accordance with particular terms. For instance, an advertisement can be uploaded or made available for download by the advertisement component 114 from the data store 125 or other external location. In one particular instance, the management component 122 can receive, retrieve, or otherwise obtain or acquire advertisements from a source such as from conventional advertisement networks or services (e.g., Admob). Of course, the management component 122 need not acquire advertisements and subsequently distribute or otherwise make available the advertisements to users. In an alternate embodiment, the management component 122 can facilitate distribution of advertisements to users directly by third-party sources or services. In either case, the management component 122 coordinates distribution of advertisements.

The compensation component 128 is configured to compensate users of computing devices. While other means of compensating a user can be employed, in accordance with one embodiment, compensation can be financial. In other words, users are paid money. In one implementation, this can be accomplished by redirecting at least a portion of revenue acquired from advertisers to users. The compensation component 128 in one embodiment can be configured to establish and maintain an account for a user that can be credited with earned compensation. After reaching a predetermined minimum value, the compensation component 128 can cause a check to be issued to the user automatically or upon user request. Other payment mechanisms can also be employed. For example, the compensation component can initiate an electronic money transfer.

The amount of compensation and the rate at which a user is compensated can vary based on a number of factors. In accordance with one aspect, a user can be compensated for providing data and allowing advertisements to be provided on the computing device of the user. For instance, a user can be compensated for providing location data and allowing display of advertisements based at least on this data. The rate of compensation can be adjusted as a function of the quantity and quality of data provided as well as for allowing more and different types of advertisements. By way of example, if a user provides personal data such as sex, marital status, and age, compensation can be increased. Similarly, compensation can be larger if a user allows an increased frequency of advertisements or additional or different advertisement means. For instance, a higher compensation rate can be provisioned for advertisements in conjunction with applications, such as a turn-by-turn direction application, or periodic audio advertisements. In the case of navigation assistance, a merchant's address can be embedded within an advertisement such that a user upon selection can acquire directions to the merchant's place of business. In this instance, a user can be compensated for traveling to the place of business. Further, compensation can be adjusted based on when the user arrives such as within minutes or days. Overall, compensation can be adjusted (e.g., increased, decreased, added, removed) to reflect a user's acceptable level of privacy and tolerance for advertisements versus a desire to make money, potentially after meeting some prerequisite levels regarding data provided and advertisement acceptance.

The intermediary component 126 exploits aspects of user compensation for use with respect to intermediaries. Herein, an intermediary is any entity (e.g., human being, company . . . ) that acts as a go between or link between consumers of products or services and producers or suppliers of the products or services. For example, an intermediary can be a purchase agent or broker, wherein products and services are procured through such agents or brokers. Moreover, to the extent agent or broker is used herein the terms are meant to refer to a specific person or a company (e.g., John Doe, insurance agent, ABC insurance company). Although not limited thereto, a purchase agent can be an insurance agent, through which insurance products (e.g., car, home, life, health . . . ) are acquired, in accordance with one embodiment. For instance, compensation or compensation rate can depend on a user providing personal information useful for such agents. In one scenario, a form or questionnaire can be provided requesting particular information, and completing or failing to complete the form can affect the compensation, potentially terminating all compensation. Designating a particular individual as the user's agent can also be requested (or purchasing insurance at renewal time through the designated agent), wherein compliance or failure to comply can influence compensation or the rate of compensation. Further, authorization can be solicited from a user to accept one or more agent-selected providers of products or services. For example, a designated insurance agent can request the user switch insurance providers or renew with a particular insurance provider. Again, complying with request or failure to comply can affect compensation or the rate of compensation. Additionally, formal designation and/or authorization may not be required. Rather, user compensation can be affected simply based on whether or not an intermediary is used by a user.

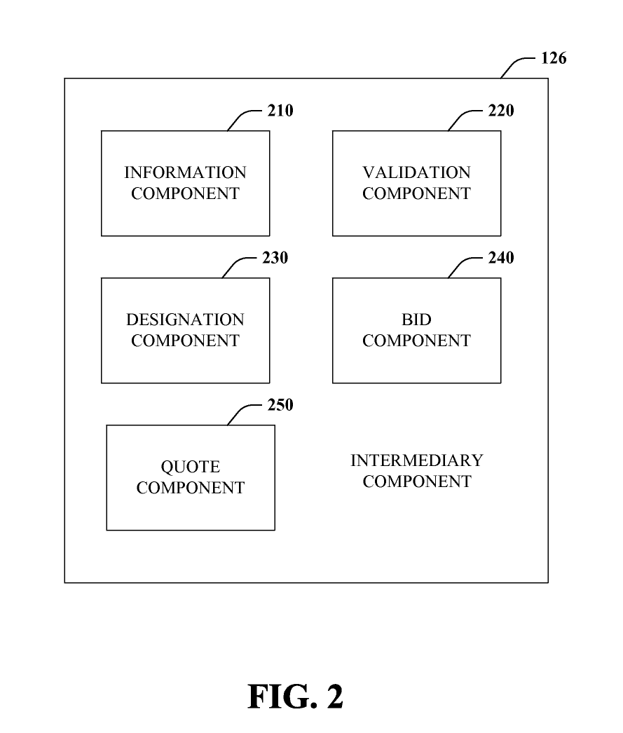

Turning attention to FIG. 2, a representative intermediary component 126 is illustrated in further detail. The intermediary component 126 includes information component 210 and validation component 220. The information component 210 is configured to request and receive or retrieve information useful to an agent from a user. In accordance with one aspect, a form or questionnaire can be provided to a user for completion. For instance, the form may request personal information such as name, address, driver's license number, date of birth, and vehicle identification number, among other things. Further, the information component 210 can request permission to acquire information from external sources, such as the user's driving record from government records. The validation component 220 provides a means of validating the information provided by a user. In one scenario, the validation component 220 can compare information to databases of information, for example to check whether the name of the user corresponds to an address for the user. Other mechanisms can also be employed. By way of example, a user may be asked to take a photograph of his/her car's vehicle identification number (VIN), which can be compared to an entered VIN for purposes of validation.

The intermediary component 126 also includes designation component 230. The designation component 230 is configured to request that a user of a computing device designate a particular individual as his/her agent, for example, with respect to purchase of particular goods or services. In one instance, this can correspond to requesting authorization to send a letter to the user's insurance company requesting a change of agent of record for his/her insurance. After receipt of agent designation, the designation component 230 can be configured to at least initiate such designation, for example by generating a letter requesting a change of agent.

The intermediary component 126 also includes bid component 240, which is configured to request and receive or retrieve bids from product or service providers for one or more individuals. The bids can include intermediary commission and other compensation such as bonuses for certain volumes attained or share of contract profit. Based on this information, an intermediary can select a product or service provider, for instance which have the same demographics profitability profile or risk profile. In other words, the bid component 240 is configured to execute an auction for the business of individuals represented by the intermediary based on the overall level of intermediary compensation.

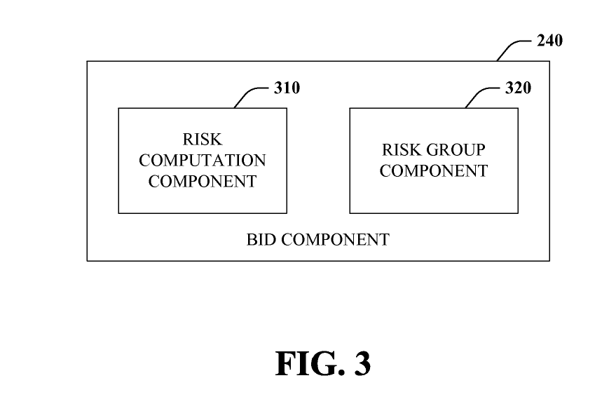

Turning attention briefly to FIG. 3, a representative bid component 240 is depicted. The bid component 240 includes risk computation component 310 and risk group component 320. The risk computation component 310 is configured to compute risk for a person based at least in part on information acquired. In one instance, the risk computation component 310 computes key parameters or scores representative of the potential profitability of the customer for a new product or service provider based on risk. The higher the risk, the lower the profitability potential and the lower the bid that the product/service provider would be willing to pay as a compensation for the agent to switch that customer to the provider. By way of example some factors that can be considered to access risk with respect to car insurance can be as follows:
Mileage per month
Types of roads traveled (x % of mileage on highway versus city roads versus rural roads)
Risk of roads traveled (x % on roads considered high risk based on number of accidents reported on those roads)
Time of day traveled (x % of mileage during day versus evening versus night).
Location of home area
Location of work area
Distance between home and work
Average speed on roads versus speed limits on those roads (e.g., drove on average 65 miles per hour on roads that have 60 miles per hour speed limits)
Age
Marital status
Risk level of car types
Number of sudden accelerations
Number of sudden decelerations
Number of zigzag/tailgating/lane changing behaviors
   Importance can be assigned to each factor and an overall risk level or factor can be computed for a specific user. The risk group component 320 is configured to assign a person to a particular group based on his/her risk. In one instance, the risk group component 320 is configured to group high-risk people with low-risk people to some extent to produce a desirable group (an insurance provider is not likely to want a group of high-risk people). Bids can then be acquired for groups from companies based on their risk appetite.

In the context of insurance, computed profitability is largely dependent upon risk. However, profitability can vary in other contexts. For instance, known or predicted profitability can be based on a user's home neighborhood, income level and/or occupation. By way of example, and not limitation, a first person who lives in an affluent neighborhood may be deemed more profitable than a second person who lives in an impoverished neighborhood based on the likelihood that the first person has higher discretionary income.

Returning to FIG. 2, the intermediary component 126 also includes quote component 250. Once a company is selected based on its bid (e.g., highest bid), the quote component 250 can be invoked to produce or at least initiate producing quotes for users in a group. The quote can be provided to a user alone with a request to authorize adding a provider of products or services or switching from a first provider of products or services to a second provider. For example, in the insurance context, the user can be provided with a quote for insurance, such as automobile insurance, and requested to authorize switching to a new insurance provider or renewing with a current insurance provider. User compensation can be impacted by whether or not authorization is provided. In one instance, the rate of compensation can be increased if the user provides authorization. Alternatively, the rate of compensation can be decreased or compensation terminated altogether, if the user does not provide authorization. Further, a threshold can be set regarding how compensation is affected with respect to authorization or non-authorization. For example, if the quote is provided and the price of switching to a new provider is within a predetermined percentage (x %) of the price of an old provider, compensation can be terminated or reduced, if a user does not provide authorization for the switch. On the other hand, if the compensation is outside the threshold difference and a user provides authorization to switch or renew, compensation may be increased.

Although actions are described with respect to designating a purchase agent, for example, the claimed subject matter is not limited thereto. Rather, any user can be requested to perform substantially any action. In accordance with another embodiment, a user can be requested to purchase a product or service from a business through a website or telephone call center. Here, an intermediary can be a referring entity as opposed to a designated purchase agent. Nevertheless, the intermediary can be compensated for generating business. For example, an intermediary can be compensated for business produced by purchasing insurance through a particular website or call center. In this instance, even if an intermediary directs substantially all advertising revenue to users of an application supplied by the intermediary, he/she can still be compensated by requesting users purchase products or services through from a business by way of some mechanism.

Overall, the compensation system 100 provides a plurality of benefits. For users, the system provides a mechanism to be compensated for providing data, allowing advertisements to be presented or otherwise delivered, and on occasion performing particular actions. Further, compensation can be tailored to a user based on his/her comfort level in providing data and tolerance for advertisement. For intermediaries the system provides at least two advantages. First, an intermediary is provided with a cost effective way to reach potential customers on a large scale. Second, the intermediary is provided increased leverage in negotiating commissions and other compensation terms with providers of products or services.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity and so as not to obscure inventive aspects, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, among others, can automate certain mechanisms or processes performed thereby to make portions of the systems and methods more adaptive as well as efficient and intelligent. By way of example, and not limitation, such mechanism can be employed to infer information about users based on data provided, determine user profitability and compensation provisioning or adjustment.

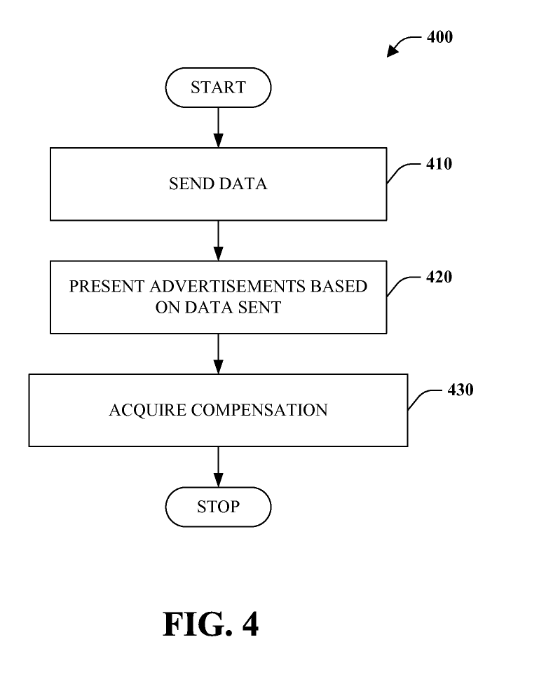

In view of the exemplary systems described above, methodologies that may be implemented in accordance with the disclosed subject matter will be better appreciated with reference to the flow charts of FIGS. 4-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a user compensation method 400 is illustrated. In accordance one embodiment, the method 400 can be performed by an application executing on a user's computing device such as a laptop, tablet, or mobile phone. At reference numeral 410, data is sent or otherwise made accessible. The data can pertain to a user of a computing device. For example, the data can correspond to location, speed, and acceleration from sensors of the computing device. Of course, data is not limited thereto and can correspond to other data or information directly provided or indirectly retrieved, determined or inferred, such as name, address, sex, age, marital status, and driver's license number. At reference 420, one or more advertisements are displayed, presented, or otherwise delivered based on the data sent. The advertisements can be text, graphics, pictures, audio, video, or a combination thereof Further, since the advertisements are based on data about a user they are targeted advertisements. At reference numeral 430, compensation is acquired such as financial compensation. For example, a user account can be credited a portion of the advertisement revenue.

In accordance with one aspect, a user can control the data that is sent as well as the frequency, type, and delivery of advertisements (e.g., text, graphics, images, audio, and/or video, on lock screen, as part of turn-by-turn direction . . . ). Accordingly, compensation or the rate thereof can be based on the data provided and advertisements allowed by a user. Additional compensation can also be provided, for example if a user selects an advertisement (e.g., click through, interaction) as well if the user purchases an advertiser product or service based on the advertisement (e.g., conversion). In accordance with one instance, conversion can be controlled by embedding advertising with coupon codes. Participating merchants can capture the coupon codes at time of sale and remit the discount separately.

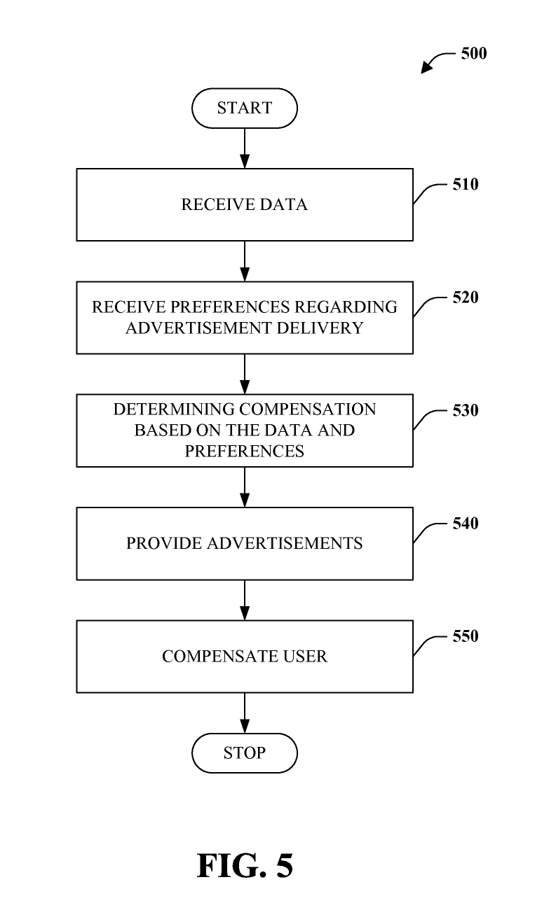

FIG. 5 depicts a user compensation method 500, which can be employed by a server or the like with respect to interaction by a client application. At reference numeral 510, data is received, retrieved, or otherwise obtained or acquired regarding a user from a computing device. The data can be any data related to the user that the user is willing to provide. In one instance, the data can be location, speed, and acceleration data captured by computing device sensors. At numeral 520, one or more preferences regarding display, presentation, or delivery of advertisements are received, retrieved, or otherwise obtained or acquired. Among other things, the preferences can relate to the frequency of advertisements, the type of advertisement, as well as when, where, and how advertisements are delivered on a user computing device. In other words, the one or more preferences define advertisements a user is willing to allow or accept. At numeral 530, compensation is determined based at least on the data provided and the advertisement preferences. For example, if a large quantity of data is provided and few, if any, advertisement restrictions are specified, more compensation or a higher rate of compensation can be provide than for a relatively small quantity of data with a large number of restrictions. At numeral 540, one or more advertisements are provided or otherwise made available for presentation by way of a user-computing device. For instance, advertisements can be uploaded at a specific point in time, such as overnight, or a location provided from which the advertisements can be downloaded. The advertisement when delivered can also include, among other things, commercial ringtones, videos infomercials, tailored discount offers and merchant address information for easy turn-by-turn directions to a store, for example. The additional targeting capabilities are expected to be welcomed by the user, as they would trigger higher compensation. Other downloadable components could include entertainment such as music and podcasts as added value to be played between advertisements. In other words, distribution of advertisements is coordinated as well as customizable. At reference 550, a user is compensated for providing data and accepting advertisements, wherein accepting advertisements does not require explicit selection of advertisements but rather merely permitting or allowing advertisements to be delivered to a user by way of a computing device of the user. In accordance, with one embodiment compensation can include crediting an account of a user. After a minimum balance is achieved, periodically or upon user request, a check can be issued or other electronic payment mechanism employed to transfer payment to a user's bank account, for example.

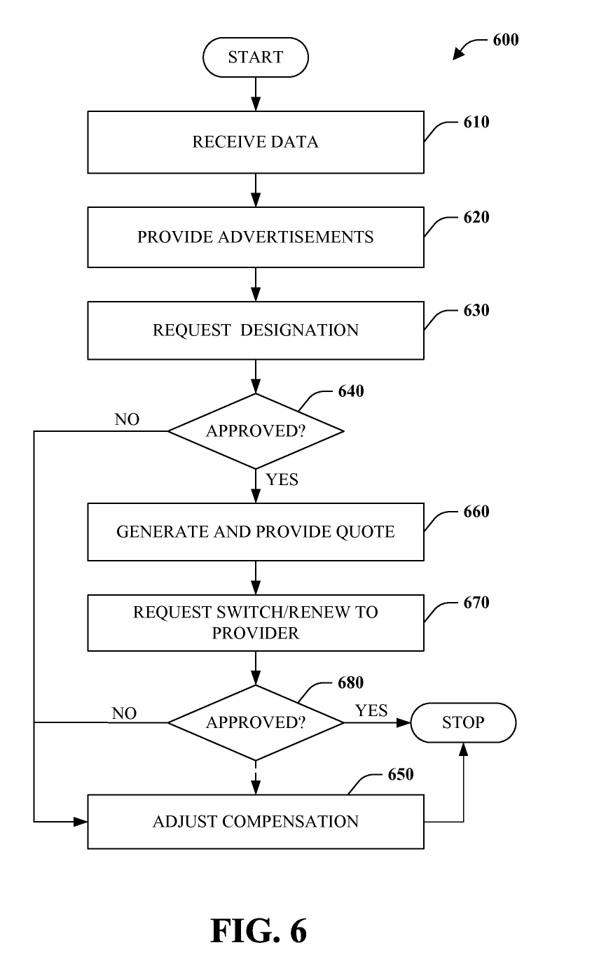

FIG. 6 illustrates a method 600 of intermediary designation and purchase with user compensation. At reference numeral 610, data about a user is received, retrieved, or otherwise obtained or acquired. As examples, the data can be received from one or more computer device sensors or directly from user specification. At numeral 620, one or more advertisements can be provided to a user or otherwise made accessible to a user. For instance, an advertisement can be pushed to a user's computing device or the advertisement can be downloaded from a specified location. At reference 630, a request is made to designate or agree to use a particular entity as an intermediary for the user, such as a purchase agent. For instance, the request can pertain to designating a particular person as an insurance agent for purchase of automobile insurance. At 640, a determination is made as to whether the user approved or authorized designation of person as the user's agent. If the user does not approve the designation (“NO”), the method continues at numeral 650, wherein compensation is adjusted to reflect the disapproval. In one instance, all compensation can be terminated. Alternatively, the compensation or rate thereof can be decreased by some factor. For example, algorithms employed for compensation that take the following into consideration: 1) The user has in the past authorized a designation; 2) The designated purchase agent was successful in recovering compensation from a provider; 3) The value of that compensation; 4) The user is a very active social node in the social channel (which, when subscribed to simulcasts user generated personal ads that are paid by individuals rather than merchants; 5) The monthly mileage of the user; 6) The propensity of the user to recommend the application to other users; and 7)The value of the users to the base of advertisers in terms of demographics and location patterns. If, at 640, the intermediary designation was approved (“YES”), the method continues at 660. Here, a quote can be a generated and provided to a user for purchase of a product or service from an intermediary-preferred provider (e.g., highest compensation bid). At reference numeral 670, a request is made for the user purchase one or more products or services from an intermediary-preferred provider. For example, the request can be to switch to a preferred provider for a product or service, if the user currently purchases from a different provider. Alternatively, if the user currently purchases a product or service from the preferred provider, the request can be to renew a policy or purchase agreement but through a different intermediary and with compensation flowing to the designated intermediary, for instance. At numeral 680, a determination is made as to whether the user approved or authorized the requested switch or renewal. If the user disapproves the switch or renewal request (“NO”), the method continues at 650, wherein a compensation adjusted is made to reflect the disapproval. For example, all compensation can be terminated or compensation, or the rate thereof, can be reduced by some factor. If, at 680, the user approves the switch or renewal (“YES”), the method can simple terminate. Rather than simply penalizing users for not authorizing intermediary designation and switch or renewal, users can be rewarded for such authorizations. Accordingly, if, at 680, the switch or renewal is approved, the method can optionally proceed to 650 prior to terminating, wherein compensation is adjusted. In this situation, adjustment can correspond to increasing compensation, providing a single payment, or increasing the flow of available targeted promotional offers from merchants.

Note that while FIG. 6 pertains to requesting designation and authorization with respect to an intermediary and purchase of products or services through the intermediary, in another embodiment such formal requests and responses need not be required. For instance, compensation can be provided or adjusted based on whether or not an intermediary is used by a user with respect to purchase of a product or service without formal designation and/or authorization.

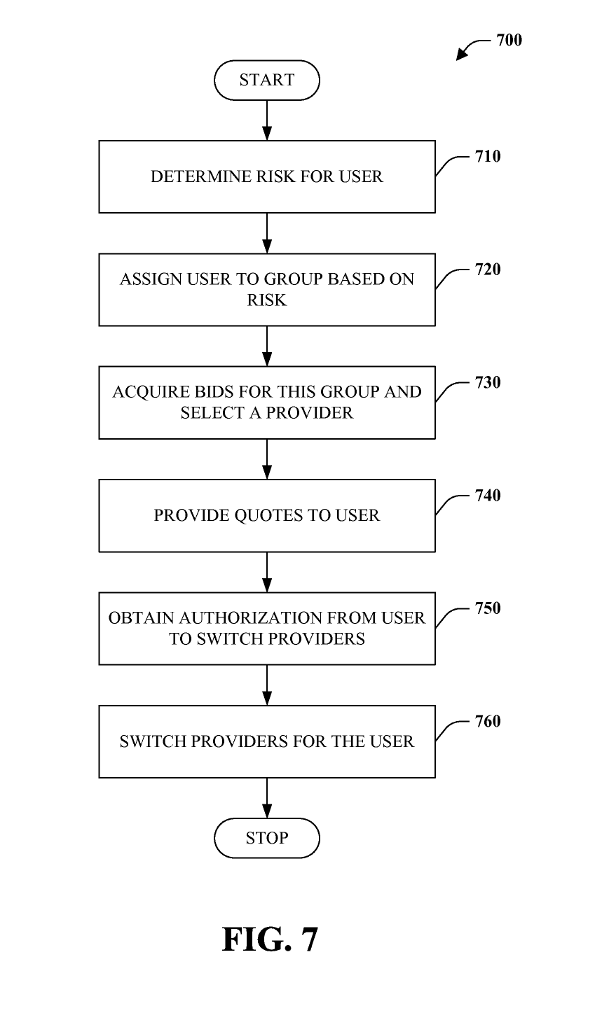

FIG. 7 is a flow chart diagram of a method 700 of switching providers of products or services. At reference numeral 710, risk, or a risk factor, is determined for a user. The determination can be made based at least in part of data provided by the user through a system that compensates the user for providing such data and accepting advertisements. More specifically, an actuarial risk algorithm, profitability predictive algorithm, or the like can be employed that assigns specific importance to various factors and computes an overall risk factor for a specific user and for specific type of product/service providers, such as for example car insurance companies. At numeral 720, a user is assigned to group of users based on the computed risk. For example, a high-risk user can be grouped together with a low-risk user to produce a group with a desired risk level. Packaging of users inside specific groups can employ algorithms that account for a plurality of factors that affect user risk level and predicted profitability level for the provider. At reference 730, bids are acquired for this group and a provider is selected. More specifically, the group can be auctioned to the highest bidder in terms of at least agent compensation, for example and for products and services similar to the ones the user desires to acquire. Potential product or services providers can have access to the specific raw or anonymized data of users in the group to aid bidding. Preference could be given to bids that use the calculated risk levels or predicted profitability levels. Bids can be provided for the group and a provider selected based thereon. At reference numeral 730, a quote is provided to the user, which reflects the cost of a particular provider of a product or service. At numeral 750, authorization can be requested and obtained from the user to switch providers (or renew with a current provider). At reference numeral 760, a provider switch is performed for the user. One or more advertisements are delivered to a user (e.g., presented, played . . . ) based on data supplied by the user. At numeral 830, a request to purchase a product or service from or through a business is made. For example, a user can be directed to a website or call center to purchase a product or service such as car insurance, among other things. At reference numeral 840, the user can be compensated based on his/her response to the request. For example, the user can be compensated financially for purchasing the product. Additionally or alternatively, one or more additional opportunities to make money in exchange for sharing data can be made available. Of course, if the user does not purchase a product or service as requested, the user may be penalized for example by reducing a rate of payment with respect to sharing data and accepting advertisements. In one instance, the user may be prevented from being compensated at all.

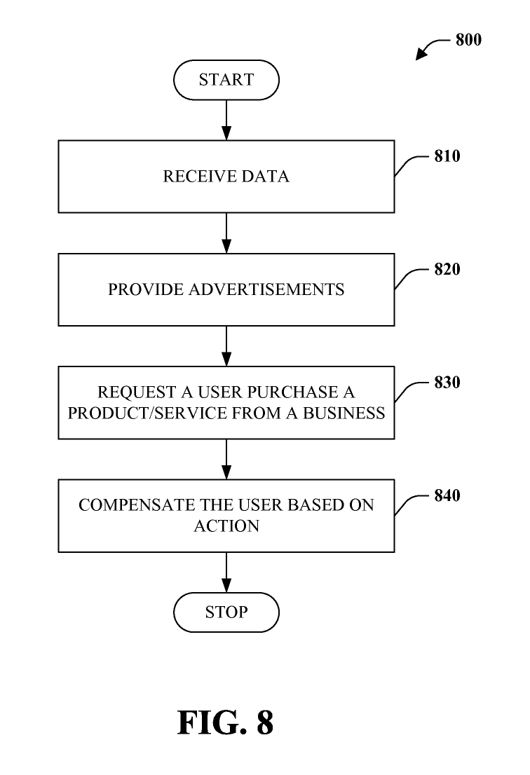

FIG. 8 depicts a method of user compensation 800. At reference numeral 810, data is received, retrieved or otherwise obtained or acquired regarding a user of a computing device. Such data can include location, speed, name, and address among other things that are specified by a user or otherwise determined or inferred. At numeral 820, one or more advertisements can be provided to a user or otherwise made accessible to a user. For instance, an advertisement can be pushed to a user's computing device or the advertisement can be downloaded from a specified location. At numeral 830, a request is provided to a user to perform an action relating to the purchase of a product or service from business. In one embodiment, the action is purchasing a product or service from a business referred by a specific intermediary. In other words, rather than purchasing a product directly from a business, the user can be directed to purchase the indirectly through an intermediary such that the intermediary receives a referral fee or other compensation. For example, a user can be guided to purchase a product through a website of the intermediary. At reference numeral 840, the user can be compensated based on the action. For instance, the user can be compensated with a lump sum or signal payment for purchasing a product through the intermediary. Alternative compensation can include increasing a rate of payment or providing access to more additional moneymaking opportunities, among other things.

What follows is description of a plurality of different advertisements that can be employed in conjunction with the subject disclosure. These advertisements are merely exemplary and represent solely a subset of potential advertisements that can be employed. Further, while the advertisements may be described in the context of user compensation and auctioning users based on intermediary compensation, the advertisements are not limited thereto.

In one instance, audio advertisements can be employed. For example, the volume of a computing device can be overridden and audio advertisements played, in one instance at full volume. Audio advertisements can also be converted into ringtone and played when the advertisement is acquired. Furthermore, audio advertisements present an opportunity for users to increase their compensation. Advertisers may pay a premium for an audio advertisement, with a portion of the money going to the user, if the user interacts with the advertisement and yells loudly the brand being advertised, for instance. Using existing speech recognition tools, it can be determined if the brand name has been repeated by the user and how loud he was when yelling the brand name. Advertisers are expected to pay significant premiums for these types of interactive advertisements as it ensures them that the user has in fact heard and received the advertisement. The premium may be equivalent to the price differential between a display advertisement and a click online.

Advertisements can also be presented in conjunction with phone number dialing on a mobile phone. By way of example, an advertisement can be displayed or played each time the user attempts to dial a number (other than 911).

In accordance with one embodiment, data provided by a user can correspond to the user's current location. Tracking location over time can enable pieces of information to be determined or inferred. For example, utilizing such location data the user's home, place of work, and preferred place of entertainment, among other things can be determined or inferred. More specifically, the place a user is located weekdays during the week can be labeled the user's place of work, the place a user is located spends most nights can be identified as home, and common locations on Friday and Saturday nights can be considered preferred places of entertainment.

Further, location data can also aid in identifying usual or habitual routes such a route to work, routes to a preferred mall, or the routes to a preferred nightclub. In one embodiment, advertisers can bid on routes so that when the user appears to have gone on a specific route, advertisers can place the ad way before the user arrives close to their place of business. By way of example, if through analysis of location patterns, it is determined that the user, at 7 a.m. takes a highway entrance on exit #7 and then exits to a place of work on exit 20, then a merchant, such as a restaurant, located on exit 18 which is 2 miles before exit 20 might want to advertise five or ten minutes before the user passes his exit or else lose a chance of convincing the user to modify his route to stop for breakfast at the restaurant. This allows users to maximize their revenue by way of compensation by allowing merchants to not only advertise to users who are in the vicinity (e.g., within “x” miles) of their place of business but also allow merchants to advertise in advance to the users who are coming from a specific neighborhood and on a route that will pass through the vicinity of their place of business within a particular time interval of ad placement.

Routes can also be used to download in advance predetermined advertisements that will be placed the next day so that they can be downloaded at night and run the next day at the appropriate moment when the location triggers a specific advertisement from specific merchants. In one instance, this can be employed in conjunction with download of some podcasts and music to play during the route to work so that it can preempt the user from using too much radio that may interfere with audio advertisements. In effect, this can function like a disc jockey playing music, podcasts, and audio ads during a drive to work and drive home.

Advertisements can be incorporated with directions. In accordance with one aspect, a user can be compensated for triggering a turn-by-turn directions to a specific merchant. For example, an advertisement can include or by linked to an address for an advertising merchant and provide an option for a user to initiate directions to the merchant. If this option is triggered, it can be determined by location tracking that a user did in fact go to a store of the merchant advertising and the length of time spent at the store. Advertisers may pay a premium for advertisements that lead a user to visiting an advertiser's store, and thus a user can be compensated for this activity. In another instance, a user may wait a predetermined amount of time and if within that time the user visits the location of the advertiser and stayed there for set time, then a the user can receive a credit.

In accordance with another aspect, an advertisement can include an advertisement code (e.g., numeric, bar code . . . ) that a user can present to the merchant when that user is purchasing an item at a merchant's store. In one embodiment, cashiers at a store can be instructed to provide back to the user, in return for the advertisement code, a discount code that the user can then be utilized to acquire credit for this activity. Using this method, merchants can deliver discounts to specific demographics without extending it to the entire population. For example, an advertiser can provide discounts based on the type of car a user drives or the neighborhood where the user lives.

Advertisements can also be utilized in conjunction with social networks. As the number of users of the subject compensation system increases in a specific city, a user's routes can be correlated with routes of friends identified on one or more social network services (e.g., Facebook, LinkedIn . . . ). This can be used to suggest carpooling or to suggest that friends meet up at the same destination. By way of example, and not limitation, if every weekend a user and one or more friends take the same route to go downtown around the same time, a suggestion can be made to carpool or meet up. In one embodiment, users can share routes with their friends or bookmark places they would like their friends to see with one click. Friends or other social network contacts can be obtained by logging to the compensation system or portion thereof with a social network service account or automatically based on setup information.

In accordance with one embodiment, advertisements promoting businesses can be acquired from conventional advertiser networks (e.g., Admob). However, advertisements can also promote individuals and be user generated in accordance with another embodiment. For instance, individuals may want to promote themselves for dating or socialization purposes (e.g., social advertisement) or to sell some item (e.g., personal advertisement). Users can be encouraged to produce personal advertisements by way of tools to aid production such as an easy way to record a voice advertisement, upload related pictures, and show a map where the user can outline the location and time where ads will be presented. Furthermore, a mechanism can be provided to allow a user to specify one or more locations, such as roads, where the advertisements will be presented by simply driving particular roads and using a bookmarking mechanism to set the location.

People can subscribe to a social channel or the like to receive social and personal advertisements of users. These social advertisements may not result in compensation to listeners or viewers who instead are obtaining the value of being connected. As per personal advertisements, a person may be required to either pay money for the advertisement or provide valuable personal information, for example before being able to open messages sent by people responding to his or her personal ads.

One category of personal advertisements can take advantage of location-based tracking. By way of example, and not limitation, a group of people can “advertise” the fact that they will attend a particular event or patronize a specific club by providing pictures, videos, or voice recordings that are pushed or uploaded to a social channel subscribed to by a people with specific demographics in terms of gender, age, or driving pattern, among other things. A receiving individual can be presented with the choice of expressing support by “liking” the advertisement as well as going to the location, where his/her presence can be confirmed. In order to open the pictures and messages sent by people that “liked” the advertisement. The group of people may be required to first be present at the location and also either make payment or provide significant personal information, for example which could lead to capturing commissions on products or services, such as insurance. Once opened, messages could be exchanged between the group that posted the advertisement and the group that liked the advertisement.

Another type of advertisement is review or word of mouth advertisements. Similar to social and personal advertisements, a channel, or other mechanism, can be established to allow receipt of these advertisements. By way of example, several participating stores and merchants can show terms for a bonus related to bring a friend or other person to a store. For instance, the terms can be if a user brings three people to the store, then the user receives a ten-dollar gift certificate for the store. In accordance with one embodiment, users can convince others to visit a store through review or word-of-mouth advertisements funded by payment of money or by providing significant personal information.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

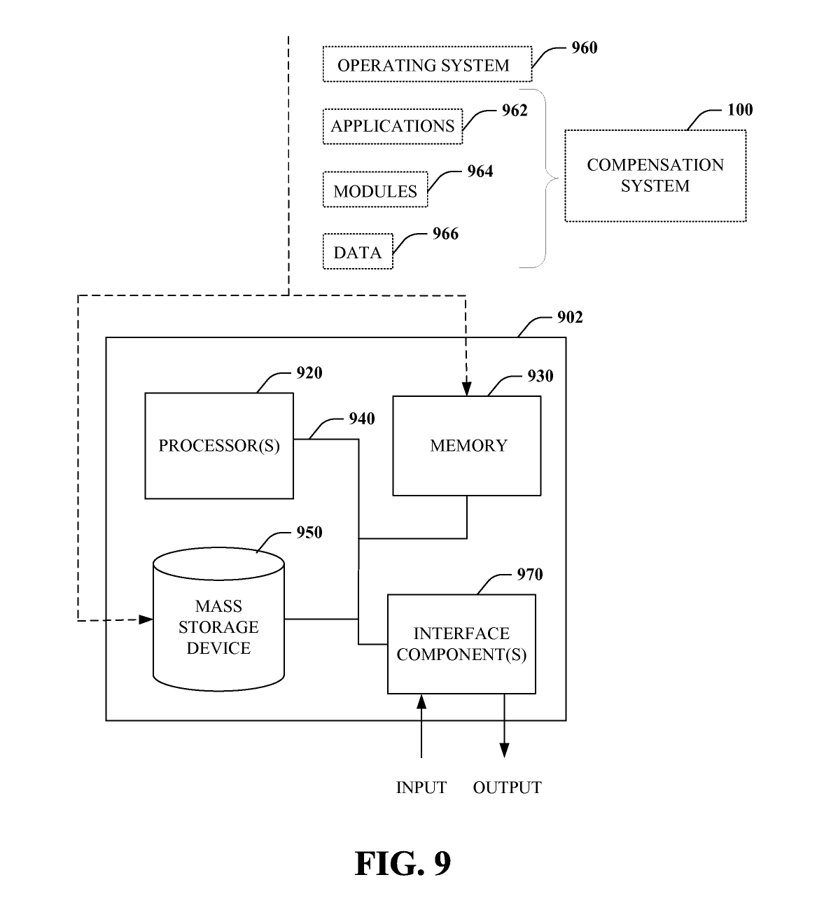

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held or mobile computing devices (e.g., mobile phones, wireless handsets, pads, mobile wireless tracking or data only devices, tablets, personal digital assistant (PDA), phone, watch, wearable computing devices, . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer or computing device 902 (e.g., desktop, laptop, tablet, server, hand-held, programmable consumer or industrial electronics, mobile phone, wireless handset, wireless data only device, set-top box, game system, compute node . . . ). The computer 902 includes one or more processor(s) 920, memory 930, system bus 940, mass storage device 950, and one or more interface components 970. The system bus 940 communicatively couples at least the above system components. However, it is to be appreciated that in its simplest form the computer 902 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 902 can include or otherwise interact with a variety of computer-readable media to facilitate control of the computer 902 to implement one or more aspects of the claimed subject matter. The computer-readable media can be any available media that can be accessed by the computer 902 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 902. Accordingly, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage device 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 902, such as during start-up, can be stored in nonvolatile memory, while volatile memory can act as external cache memory to facilitate processing by the processor(s) 920, among other things.

Mass storage device 950 includes removable/non-removable, volatile/non-volatile computer storage media for storage of large amounts of data relative to the memory 930. For example, mass storage device 950 includes, but is not limited to, one or more devices such as a magnetic or optical disk drive, floppy disk drive, flash memory, solid-state drive, or memory stick.

Memory 930 and mass storage device 950 can include, or have stored therein, operating system 960, one or more applications 962, one or more program modules 964, and data 966. The operating system 960 acts to control and allocate resources of the computer 902. Applications 962 include one or both of system and application software and can exploit management of resources by the operating system 960 through program modules 964 and data 966 stored in memory 930 and/or mass storage device 950 to perform one or more actions. Accordingly, applications 962 can turn a general-purpose computer 902 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, compensation system 100 or portions thereof can be or form part, of an application 962, and include one or more modules 964 and data 966 stored in memory and/or mass storage device 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the compensation system 100 and/or associated functionality can be embedded within hardware in a SOC architecture.

The computer 902 also includes one or more interface components 970 that are communicatively coupled to the system bus 940 and facilitate interaction with the computer 902. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 902, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., LCD, LED, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
coordinating distribution of one or more advertisements to a computing device based on data provided by a user of the computing device; and
compensating a user of the computing device for accepting the one or more advertisements based on data provided by the user.

2. The method of claim 1 further comprises requesting the user perform an action.

3. The method of claim 2 further comprises adjusting compensation based on a response from the user to the request.

4. The method of claim 2 further comprises requesting the user perform the action of designating an entity as an intermediary for the user and adjusting compensation based on a response to the designation request.

5. The method of claim 4 further comprises requesting authorization to change product or service provider and adjusting compensation based on a response to the authorization request.

6. The method of claim 2 further comprises requesting the user perform the action of purchasing a product or service from a business referred by a specific intermediary.

7. The method of claim 1 further comprises adjusting compensation based on usage of a specific intermediary by the user.

8. The method of claim 1 further comprises compensating the user of the computing device based on advertisement type.

9. A system, comprising:
a processor coupled to a memory, the processor configured to execute the following computer-executable component stored in the memory:
a first component configured to manage distribution of one or more advertisements to a computing device and compensation to a user of the computing device based on data regarding the user of the computing device.

10. The system of claim 9, the data comprises designation of an individual as an intermediary for the user.

11. The system of claim 10, the intermediary is an insurance agent.

12. The system of claim 9, the data comprises authorization to switch from a first product or service provider to a second product or service provider.

13. The system of claim 9 further comprises a second component configured to compute predicted profitability associated with the user.

14. The system of claim 13 further comprises a third component configured to assign the user to a group based on the predicted profitability.

15. The system of claim 9 further comprises a second component configured to compensate the user.

16. The system of claim 15, the second component is further configured to adjust compensation based on use of a particular intermediary by the user.

17. A computer-readable storage medium having instructions stored thereon that enable at least one processor to perform a method upon execution of the instructions, the method comprising:
acquiring data about a user of a computing device;
coordinating distribution of one or more advertisements to the computing device; and
compensating the user based on the data and one or more advertisements.

18. The computer-readable storage medium of claim 17, the method further comprises requesting designation or usage of an entity as an insurance agent for the user and adjusting compensation based on a response.

19. The computer-readable storage medium of claim 17, the method further comprises requesting authorization to change an insurance provider for the user and adjusting compensation based on a response.

20. The computer-readable storage medium of claim 17, the method further comprises requesting the user purchase a product or service from an entity and adjusting compensation based on a response.
